(19) United States
(12) Patent Application Publication
(10) Pub. No.: US 2026/0004286 A1
(43) Pub. Date: Jan. 1, 2026

(54) SYSTEM AND METHOD FOR SECURE AND PERFORMANCE-OPTIMIZED MANAGEMENT OF BLOCKCHAIN-BASED TOKEN LIFE CYCLE OPERATIONS

(71) Applicant: Pitchmatter Inc, Newark, DE (US)

(72) Inventor: Joseph Chacko, Newark, DE (US)

(21) Appl. No.: 19/308,368

(22) Filed: Aug. 25, 2025

Related U.S. Application Data
(63) Continuation-in-part of application No. 18/788,159, filed on Jul. 30, 2024.

(51) Int. Cl. G06Q 20/38; G06Q 20/40; H04L 9/00; H04L 9/32

(52) U.S. Cl. CPC G06Q 20/3827; G06Q 20/3825; G06Q 20/3829; G06Q 20/401; H04L 9/3213; H04L 9/3247; H04L 9/50

(57) ABSTRACT

The present invention relates to a system for secure and performance-optimized management of the entire token life cycle operations in decentralized investment ecosystems, especially applicable to blockchain platforms integrating immutable hardware-enforced parameters, trusted execution environments, multi-source price oracles, hybrid mint-and-buyback token allocation mechanisms, and compliance-gated vesting schedules to provide tamper-resistant, revenue-funded investor protection and resilience against network manipulation. The system enforces strict supply and governance safety bounds at the hardware level, preventing any software-based or governance-initiated override of critical operational parameters. The system integrates real-time, TEE-verified oracle feeds, MEV-resistant commit-reveal protocols, and cryptographically verifiable event logging to ensure data integrity, mitigate transaction ordering attacks, maintain compliance throughout the vesting period, and enable efficient off-chain auditing without requiring full-chain scans.

### FIELD OF THE INVENTION

The present invention relates generally to blockchain-based systems and, more particularly, to a system for secure and performance-optimized management of blockchain-based token life cycle operations in decentralized investment ecosystems. The invention is especially applicable to blockchain platforms integrating immutable hardware-enforced parameters, trusted execution environments, multi-source price oracles, hybrid mint-and-buyback token allocation mechanisms, and compliance-gated vesting schedules to provide tamper-resistant, revenue-funded investor protection and resilience against network manipulation.

### BACKGROUND

Blockchain-based token systems are widely used for representing digital assets, facilitating decentralized finance (DeFi) operations, and enabling governance in distributed autonomous organizations (DAOs). In conventional architectures, token lifecycle management—comprising issuance, allocation, transfer, burning, vesting, and governance—is typically executed entirely by on-chain smart contracts without dedicated hardware-based safeguards. Such implementations rely on externally hosted scripts or manually executed procedures for key operational aspects, including price feed verification, investor allocation, and governance enforcement. While functional, these systems are vulnerable to oracle manipulation, transaction ordering attacks, governance parameter abuse, and inconsistent compliance enforcement.

Existing token management solutions often lack robust mechanisms for maintaining a strict hard cap on token supply at the protocol level. Many platforms enforce caps only at the allocation contract, which can be bypassed or compromised by upstream contract bugs or malicious upgrades. Additionally, conventional systems rely on single-source or loosely aggregated price oracles that are susceptible to stale data or outlier manipulation. Vesting schedules, when implemented, are generally static and applied only at grant time, without claim-time compliance verification. Governance processes are usually controlled by token-weighted voting without hard-coded safety bounds, making them vulnerable to governance capture or malicious parameter changes.

Certain prior art systems have attempted to address these shortcomings. For example, decentralized oracle networks have been used to aggregate multiple price feeds to mitigate manipulation. Hybrid on-chain/off-chain governance frameworks have been introduced to delay execution of governance decisions, providing time for community review. Some token contracts incorporate built-in burn mechanisms to support deflationary models, while others integrate vesting contracts for gradual token release. Additionally, commit-reveal protocols and time-weighted average price (TWAP) mechanisms have been applied to limit miner-extractable-value (MEV) attacks in decentralized exchange transactions.

Despite these incremental improvements, prior art systems remain limited in several critical ways. Multi-source oracle systems may still rely on off-chain aggregation without verifiable execution in a trusted hardware environment, leaving room for compromised feed data. Commit-reveal systems often use predictable timing parameters that can be exploited by adversaries. Governance safety remains dependent on mutable smart contract parameters, meaning a malicious governance proposal can still set catastrophic values such as excessive burn rates or slippage tolerances. Vesting mechanisms generally do not incorporate dynamic claim-time eligibility checks, failing to enforce ongoing regulatory compliance such as Know Your Customer (KYC) or jurisdictional restrictions. Moreover, prior art does not effectively integrate immutable, hardware-enforced safety bounds for token supply and governance parameters, nor does it offer a hybrid mint-and-buyback allocation mechanism that guarantees fulfillment of investor allocations while preserving strict supply caps.

As a result, current blockchain token lifecycle solutions exhibit vulnerabilities in security, compliance, and performance optimization. Attack vectors such as oracle manipulation, MEV exploitation, governance capture, and non-compliance in token release remain inadequately addressed. Furthermore, without verifiable event logging and cryptographic anchoring of allocation data, auditing such systems remains challenging and resource-intensive.

Therefore, there is a need for a system for secure and performance-optimized management of the entire token life cycle in decentralized investment ecosystems, especially applicable to blockchain platforms integrating immutable hardware-enforced parameters, trusted execution environments, multi-source price oracles, hybrid mint-and-buyback token allocation mechanisms, and compliance-gated vesting schedules to provide tamper-resistant, revenue-funded investor protection and resilience against network manipulation. There is also a need for a system that enforces strict supply and governance safety bounds at the hardware level, preventing any software-based or governance-initiated override of critical operational parameters. Further, there is also a need for a system that integrates real-time, TEE-verified oracle feeds, MEV-resistant commit-reveal protocols, and cryptographically verifiable event logging to ensure data integrity, mitigate transaction ordering attacks, maintain compliance throughout the vesting period, and enable efficient off-chain auditing without requiring full-chain scans.

### SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key nor critical elements of all embodiments, nor delineate the scope of any or all embodiments.

The present disclosure, in one or more embodiments, relates to a system for secure and performance-optimized management of blockchain-based token life cycle operations in decentralized investment ecosystems. The invention is especially applicable to blockchain platforms integrating immutable hardware-enforced parameters, trusted execution environments, multi-source price oracles, hybrid mint-and-buyback token allocation mechanisms, and compliance-gated vesting schedules to provide tamper-resistant, revenue-funded investor protection and resilience against network manipulation.

In one embodiment herein, the system comprises a computing device having a processor operatively coupled to a non-transitory memory storing executable instructions, a hardware-based Trusted Execution Environment (TEE), a network interface configured for persistent, authenticated peer-to-peer communication with a blockchain network, and a hardware-protected non-volatile memory storing immutable operational parameters including a maximum allowable token supply and governance safety bounds.

In one embodiment herein, the processor is configured to establish a persistent, authenticated peer-to-peer connection with the blockchain network through the network interface, and receive real time blockchain event logs related to token lifecycle operations. The processor is configured to generate a compressed Merkle-root data structure containing investment agreement terms, investor account identifiers, and weighting factors.

In one embodiment herein, the processor is configured to anchor a Merkle-root hash of the data structure to the blockchain network at a recorded block height to minimize on-chain storage size compared to full allocation records. The processor is configured to retrieve token price data from multiple blockchain price oracles, and execute a median-of-signatures validation model within the TEE to authenticate data freshness and exclude outlier price feeds that exceed a set deviation threshold.

In one embodiment herein, the processor is configured to determine a token allocation amount based on validated pricing and immutable allocation data, and enforce a maximum token supply defined by the hardware-secured NVM before triggering a token mint transaction at a blockchain virtual machine layer. The processor is configured to activate a decentralized exchange buy transaction for additional tokens based on a commit-reveal protocol with randomly timed commit from a verifiable random function (VRF) executed within the TEE.

In one embodiment herein, the processor is configured to verify that a time-weighted average price (TWAP) over governance-defined interval stays within a predefined slippage bound before revealing the transaction. The processor is configured to execute a token management contract that burns a first portion of transferred tokens and sends a second portion to a treasury address while exempting specified addresses stored in an on-chain hashed allow-list from the burn and routing.

In one embodiment herein, the processor is configured to store immutable vesting schedules in blockchain contract storage, including a predetermined cliff period and linear release parameters, and release vested tokens only after verifying a compliance attestation hash stored in an on-chain attestation registry, where the verification is done within the TEE. The processor is configured to process on-chain governance proposals, reject off-allowed immutable safety bounds stored in the hardware-protected NVM, and delays execution of accepted proposals until a governance-defined timelock expires.

In one embodiment herein, the processor is configured to record cryptographically verifiable events for allocation snapshot creation, price validation, token allocation, token minting, burn routing execution, compliance verification, and governance change execution on the blockchain.

In one embodiment herein, the processor generates the Merkle-root data structure by hashing concatenated deal data, investor account identifiers, and the blockchain block height and compresses data into a minimum-depth Merkle tree to minimize computational verification overhead.

In one embodiment herein, the trusted execution environment (TEE) stores private keys used for price verification, prevents unauthorized reads of memory, and provides a signed attestation of validated price data to the blockchain network.

In one embodiment herein, the commit-reveal protocol employs the VRF seed to create unpredictable commit timestamps, thereby preventing transaction ordering manipulation by blockchain miners and validators.

In one embodiment herein, the token management contract is deployed as an ERC-20-compatible contract with an embedded burn-and-route mechanism executed at a pre-transfer hook phase before balance updates in the blockchain virtual machine layer.

In one embodiment herein, the cryptographically verifiable events are recorded with an event-topic indexing scheme to allow off-chain auditors to extract targeted event categories without searching unrelated blockchain data.

In one embodiment herein, the blockchain network combines off-chain Know Your Customer (KYC), Anti-Money Laundering (AML), invoicing, and price feed services into the blockchain network, with each periodically sealing a Merkle-root commitment of service data on-chain for independent auditing.

In one embodiment herein, the immutable vesting schedules impose a cliff period of 36 months followed by a linear release schedule of 50 months, and prevent any release transaction for which compliance attestation verification is not completed.

According to an aspect, a method is disclosed for secure and performance-optimized management of blockchain-based token life cycle operations using the system. First, at one step, the computing device establishes a persistent, authenticated peer-to-peer connection with a blockchain network through the network interface, and receive real time blockchain event logs related to token lifecycle operations. At another step, the computing device generates the compressed Merkle-root data structure containing investment agreement terms, investor account identifiers, and weighting factors, and anchors a Merkle-root hash to the blockchain network at a recorded block height to minimize on-chain data size compared to full allocation records. At another step, the computing device retrieves token price data from multiple blockchain price oracles, and executes a median-of-signatures validation model within the TEE to authenticate data freshness and exclude outlier price feeds that exceed a set deviation threshold.

At another step, the computing device determines a token allocation amount based on validated pricing and immutable allocation data, and enforces a maximum token supply defined by the hardware-secured NVM before triggering a token mint transaction at a blockchain virtual machine layer. At another step, the computing device activates a decentralized exchange buy transaction for additional tokens based on a commit-reveal protocol with randomly timed commit from a verifiable random function (VRF) executed within the TEE. At another step, the computing device verifies a time-weighted average price (TWAP) over governance-defined interval stays within a predefined slippage bound before revealing the transaction. At another step, the computing device executes a token management contract that burns a first portion of transferred tokens and sends a second portion to a treasury address while exempting specified addresses stored in an on-chain hashed allow-list from the burn and routing.

At another step, the computing device stores immutable vesting schedules in on-chain contract storage, including a predefined cliff period and linear release parameters, and releasing vested tokens only after verifying a compliance attestation hash stored in an on-chain attestation registry. At another step, the computing device processes on-chain governance proposals, rejects off-allowed immutable safety bounds stored in the hardware-protected NVM, and delays execution of accepted proposals until a governance-defined timelock expires. Further, at another step, the computing device records cryptographically verifiable events for allocation snapshot creation, price validation, token allocation, token minting, burn routing execution, compliance verification, and governance change execution on the blockchain.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The accompanying drawings, which are incorporated in and constitute a part of the specification, illustrate an embodiment of the invention, and, together with the description, explain the principles of the invention.

FIG. 1 illustrates a block diagram of a system for secure and performance-optimized management of blockchain-based token life cycle operations, in accordance with embodiments of the invention.

FIG. 2 illustrates a block diagram of a multi-layer architecture of the system, in accordance with embodiments of the invention.

FIG. 3 illustrates a flowchart of a method for secure and performance-optimized management of blockchain-based token life cycle operations using the system, in accordance with embodiments of the invention.

### DETAILED DESCRIPTION

Reference will now be made in detail to the present preferred embodiments of the invention, examples of which are illustrated in the accompanying drawings. Wherever possible, the same reference numerals are used in the drawings and the description to refer to the same or like parts.

In contrast to prior systems that execute token lifecycle management exclusively through smart contracts or software logic, the present invention integrates hardware-level enforcement and computational optimizations. This integration produces technical benefits that are unattainable in purely abstract or financial models. For example, reliance on a TEE ensures that cryptographic verification and VRF operations cannot be extracted or tampered with by untrusted processes. Likewise, use of a hardware-protected NVM for storing governance bounds guarantees persistence and immutability of critical parameters, thereby improving the security of computer operations in adversarial environments.

Furthermore, the invention addresses computer-centric challenges of blockchain systems such as excessive storage consumption, vulnerability to MEV exploitation, and inefficient compliance verification. Each solution such as Merkle-root compression, VRF-based commit-reveal, and topic-indexed logging, provides a concrete and measurable enhancement in computing efficiency and resilience, thereby demonstrating that the contribution of the invention lies in improving the technology of blockchain networks themselves, rather than claiming an abstract rule of financial allocation.

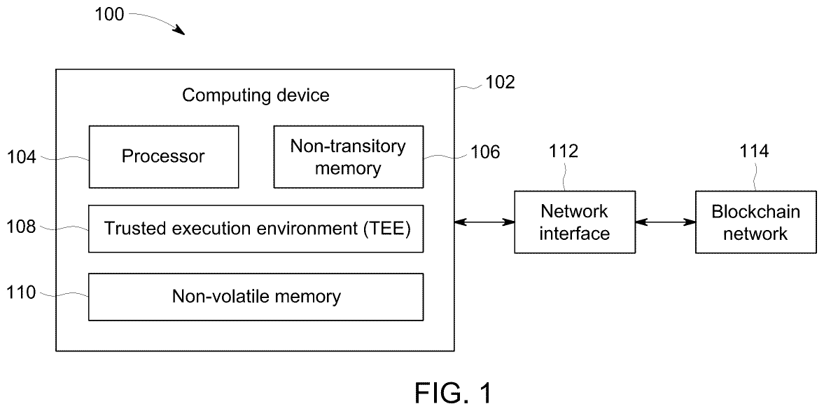

FIG. 1 refers to a block diagram of a system 100 for secure and performance-optimized management of blockchain-based token life cycle operations. The system 100 should integrate immutable hardware-enforced parameters, trusted execution environments, multi-source oracle validation, MEV-resistant commit-reveal protocols, and compliance-aware execution mechanisms to provide tamper-resistant infrastructure. The system 100 enforces strict supply, governance, and transaction safety bounds at the hardware level, preventing any software-based or governance-initiated override of critical operational parameters. The system 100 integrates real-time, TEE-verified oracle feeds, dynamic compliance checks at claim or execution time, and cryptographically verifiable event logging to ensure data integrity, mitigate ordering attacks, maintain compliance throughout operational lifecycles, and enable efficient off-chain auditing without requiring full-chain scans. In one embodiment therein, the system 100 comprises a computing device 102, which can be an electronic processing apparatus configured to execute all performance- and security-enhancing operations for blockchain-based token life cycle management. The computing device 102 may be implemented as a blockchain node, a secure hardware appliance, a general-purpose server, or a cloud-hosted virtual machine.

In one embodiment therein, the computing device 102 includes a processor 104 operatively coupled to a non-transitory memory 106 storing executable instructions, a hardware-based Trusted Execution Environment (TEE) 108 for secure execution of cryptographic and validation processes, and a hardware-protected non-volatile memory 110 for storing immutable operational parameters such as maximum allowable token supply and governance safety bounds. The computing device 102 further incorporates a network interface 112 for establishing persistent, authenticated peer-to-peer connections with a blockchain network 114, thereby enabling the computing device 102 to receive real-time event logs, anchor Merkle-root commitments, execute price validation models, trigger minting and burn-routing transactions, and process governance proposals in compliance with immutable security constraints.

In one embodiment herein, the processor 104 serves as a primary computational engine of the system 100, orchestrating all operations involved in token life cycle management. The processor 104 executes the instructions stored in the non-transitory memory 106, enabling functions such as Merkle-root data structure generation, commit-reveal transaction scheduling, price validation, and governance safety bound enforcement. The processor 104 is operatively coupled to the Trusted Execution Environment (TEE) 108 for secure execution of cryptographic and validation operations, thereby ensuring that sensitive computations, such as private key usage and price feed verification, are isolated from potentially untrusted system processes.

In one embodiment herein, the non-transitory memory 106 stores the executable instructions, system software, and configuration data necessary for implementing the token allocation, minting, burn-routing, compliance verification, and governance processing steps. The non-transitory memory 106 is designed to retain stored information without the need for continuous power, ensuring persistent storage of modules, communication protocols, and commit-reveal scheduling logic even in the event of system reboots or power failures.

In one embodiment herein, the TEE 108 is a hardware-isolated secure area within the processor 104 that provides a protected environment for executing sensitive code and storing confidential data. The TEE 108 securely stores private cryptographic keys, executes a median-of-signatures validation model, and runs a verifiable random function (VRF) for generating unpredictable commit timestamps. By preventing unauthorized access to intermediate computation results, the TEE 108 ensures that price feed authentication, compliance verification, and governance decision enforcement remain tamper-proof. The term “median-of-signatures validation model” refers to a statistical filtering process in which a plurality of “n” independent oracle signatures is collected for the same price feed, stale or anomalous data points are discarded when they exceed predefined deviation thresholds, and the median value of the remaining signatures is authenticated inside the Trusted Execution Environment (TEE). This provides resilience against outlier manipulation and enhances oracle data reliability.

In one embodiment herein, the hardware-protected non-volatile memory (NVM) 110 stores immutable operational parameters that define governance and security boundaries for the token ecosystem. This includes the maximum allowable token supply, governance safety bounds, and other critical configuration values that cannot be altered by on-chain governance or external intervention once provisioned. The NVM 110 serves as an ultimate enforcement layer against supply inflation or unauthorized governance actions, thereby maintaining long-term stability and security of the token life cycle.

In one embodiment herein, the network interface 112 encompasses any hardware, firmware, or software module configured to enable persistent, authenticated communication between the computing device 102 and the blockchain network 114 or associated off-chain services. The network interface 112 may be implemented as a physical communication adapter, a virtualized network component, an application programming interface (API), or a web-based application accessible through secure communication protocols, and is operable to transmit and receive blockchain event logs, Merkle-root commitments, transaction data, governance proposals, and compliance attestations in accordance with the system's operational requirements.

In one embodiment herein, the blockchain network 114 provides a distributed, immutable ledger that underpins all token life cycle management processes. The blockchain network 114 stores allocation hashes, event logs, governance proposals, vesting schedules, and compliance attestations in a tamper-resistant format. The blockchain network 114 also enables decentralized enforcement of token minting, burning, and routing rules via smart contracts while allowing off-chain services such as KYC/AML providers to periodically anchor cryptographic proofs of compliance.

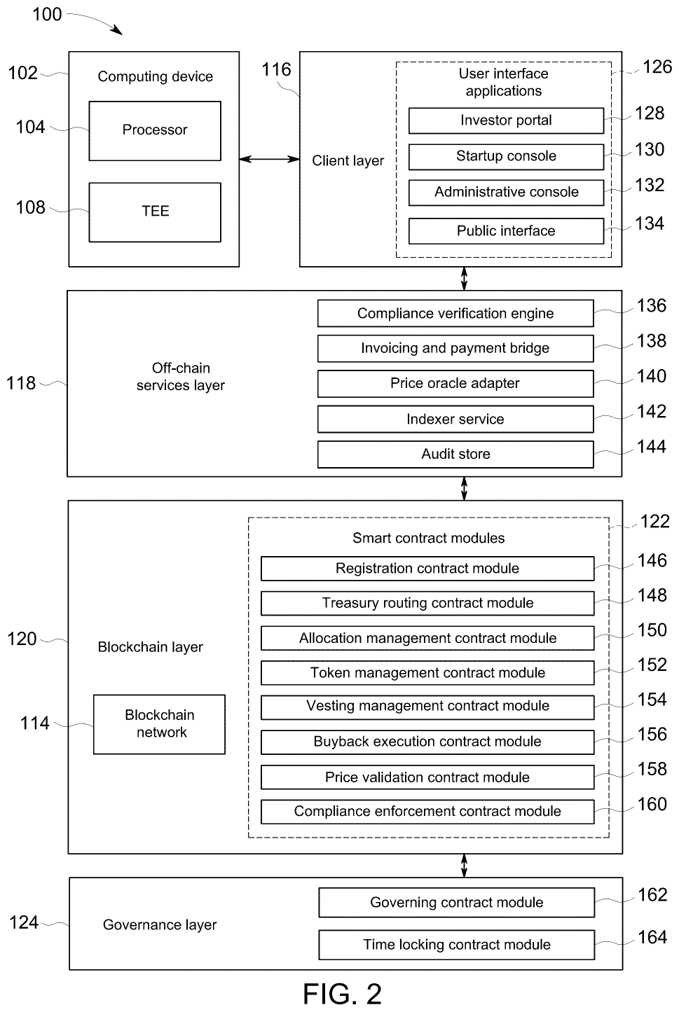

FIG. 2 refers to a block diagram of a multi-layer architecture of the system 100. In one embodiment herein, the computing device 102 executes the multi-layer architecture comprising a client layer 116, an off-chain services layer 118, a blockchain layer 120, and a governance layer 124, with the processor 104 and TEE 108 providing secure execution for each layer's operations. The combination of these layers enables the protocol to provide tamper-resistant, revenue-funded investor protection, enforce strict token supply caps, and maintain compliance throughout vesting and distribution.

In one embodiment herein, the client layer 116 comprises a plurality of user interface applications 126 including an investor portal 128 configured to connect to a digital wallet, display portfolio information, confirm participation in deals, view vesting schedules, and initiate token claims through a compliance-gated process. The user interface applications 126 also include a startup console 130 that enables creation of investment deals, acceptance of success-fee agreements, submission of investor rosters, and provision of attested funding reports. The user interface applications 126 also include an administrative console 132 with role-based access control for compliance decisioning, oracle management, dispute resolution, and submission of governance parameter proposals. The user interface applications 126 further include a public interface 134 for access to protocol documentation, risk disclosures, proposal browsing, and analytics viewing. The client layer 116 communicates bidirectionally with both off-chain services layer 118 and the blockchain layer 120, using authenticated APIs to exchange deal data, compliance attestations, and transaction metadata.

In one embodiment herein, the off-chain services layer 118 includes a compliance verification engine 136 for Know Your Customer (KYC) and Anti-Money Laundering (AML) checks, producing on-chain attestations keyed to investor wallet addresses. Additional services comprise an invoicing and payment bridge 138 for verifying receipt of success-fee payments in fiat or cryptocurrency, a price oracle adapter 140 that aggregates price data from multiple decentralized exchanges (DEXs) and centralized sources, an indexer service 142 for mirroring on-chain events into dashboard views, and an audit store 144 maintaining off-chain documentary evidence (e.g., invoices, bank slips) with periodic Merkle-root commitments anchored on-chain for integrity verification.

In one embodiment herein, the blockchain layer 120 comprises a plurality of smart contract modules 122 deployed within the blockchain network 114, implementing the on-chain logic for the token life cycle management functions. The smart contract modules 122 include a deal registration contract module 146, a treasury routing contract module 148, an allocation management contract module 150, a token management contract module 152, a vesting management contract module 154, a buyback execution contract module 156, a price validation contract module 158, and a compliance enforcement contract module 160.

In one embodiment herein, the deal registration contract module 146 stores immutable deal terms, success-fee percentages, investor lists, and metadata hashes for off-chain documentation. The deal registration contract module 146 generates deterministic allocation snapshots keyed to specific block heights to prevent post-facto alteration of investor weights. The treasury routing contract module 148 receives attested revenue receipts from the invoicing and payment bridge 138, normalizes multi-currency values via oracle-signed exchange rates, and allocates budgets among hedge issuance, liquidity reserves, and operational funds in DAO-defined proportions. The treasury routing contract module 148 includes a mapping to prevent replay attacks on “RevenueReceipt” calls. Each receipt hash incorporates a nonce and expiry timestamp, thereby ensuring that only fresh, unique, and attested success-fee payments can trigger allocations.

In one embodiment herein, the allocation management contract module 150 implements a hybrid mint-and-buyback mechanism to preserve a strict hard cap on total token supply while guaranteeing full hedge value delivery to investors. If the calculated token requirement for an allocation event is less than or equal to the remaining mintable supply, the system 100 mints the required amount directly to the vesting management contract module 154. If the requirement exceeds the remaining mintable supply, the system 100 mints only up to the allowable maximum and triggers the buyback execution contract module 156 to acquire the remaining amount from approved decentralized exchange liquidity pools. This dual-path logic ensures that, for example, 100 million token hard cap is never exceeded while investors receive the full intended hedge value, even in late-stage ecosystem operation.

In some embodiments, the allocation management contract module 150 implements gas-bounded batched allocation, where investor allocations are processed in discrete, loop-bounded transactions to ensure liveness for large investor sets. Allocation state is evented after each batch, thereby enabling off-chain indexers to reconstruct the complete allocation without exceeding per-transaction gas limits.

In one embodiment herein, the token management contract module 152 can be an ERC-20-compatible, hard-capped token implementing a transfer hook that burns a first portion (1%) of each non-exempt transfer and routes a second portion (1%) to a treasury address. Fee exemption lists are DAO-managed and hashed on-chain. In some embodiments, the ERC-20-compatible token includes a two-sided fee exemption mechanism, where both the sending and receiving addresses are checked against an on-chain allowlist before applying burn and treasury fees. This prevents recursive or unintended fee charges during protocol-internal transactions, including vesting releases, DAO operations, treasury movements, and buyback executions.

In one embodiment herein, the vesting management contract module 154 holds investor allocations in immutable vesting schedules comprising a fixed cliff period of at least 36 months followed by linear release over a defined duration of at least 50 months. The vesting management contract module 154 incorporates a claim-time compliance gate, ensuring that an investor's eligibility is verified at the moment of token release rather than only at the time of allocation. This enables the system 100 to account for regulatory changes, expired KYC attestations, or jurisdictional restrictions that may arise after the original allocation. If an investor fails compliance verification at claim time, the vested tokens remain in the vesting management contract module 154 and cannot be claimed until the investor restores eligibility, thereby aligning token release with ongoing legal and regulatory requirements.

The term “immutable vesting schedule” refers to contract storage values deployed on the blockchain network 114 that cannot be modified after deployment, except that claim-time eligibility checks (e.g., Know Your Customer (KYC) verification or jurisdiction restrictions) may be applied before the release of tokens. This ensures that vesting logic is cryptographically permanent while still permitting compliance-based gating at the moment of claim.

In one embodiment herein, the buyback execution contract module 156 executes market acquisitions of token management contract module 152 via whitelisted DEX liquidity pools, using time-weighted average price (TWAP) quotes, maximum slippage guards, and optional commit-reveal sequencing to mitigate miner extractable value (MEV) attacks. The buyback execution contract module 156 enforces maximum slippage bounds and optional price caps during decentralized exchange acquisitions. These parameters are governance-bounded and prevent overpayment or execution at unfavorable market prices, even under high-volatility conditions. Combined with TWAP quoting and commit-reveal sequencing, this approach minimizes Miner Extractable Value (MEV) risks and price manipulation.

In one embodiment herein, the price validation contract module 158 aggregates signed price data from multiple independent oracle signers, applies median-of-signatures filtering, and rejects stale or anomalous price updates. The price validation contract module 158 may enforce oracle freshness bounds by rejecting price data older than a governance-defined maximum age. Multiple independent oracle signatures are collected, and the median-of-signatures method is applied to neutralize outliers. Additionally, the system may employ pair-chaining to maintain accurate pricing even during localized feed outages.

In one embodiment herein, the compliance enforcement contract module 160 enforces eligibility requirements based on on-chain compliance attestations and jurisdiction blocklists, applied both at allocation and claim time. The compliance enforcement contract module 160 may enforce a double-gate compliance model, where the investor eligibility is verified both at allocation time (grant-time permissiveness) and at claim time (strict enforcement). The claim-time check evaluates Validity of a Know Your Customer (KYC) or Anti-Money Laundering (AML) attestation keyed to the investor's wallet, absence from an on-chain jurisdiction blocklist (ISO-3166-1 alpha-2 country codes) and global address blocklist, and optional attestation freshness, thereby ensuring that KYC/AML credentials have not expired. If the investor fails eligibility at claim time, the vested tokens remain in the vesting management contract module 154 until compliance is restored, thereby maintaining legal conformity without retroactive clawbacks.

In one embodiment herein, the governance layer 124 implements an on-chain, tokenholder-driven decentralized autonomous organization (DAO) configured to manage privileged protocol parameters, smart contract upgrades, and treasury operations in a transparent and decentralized manner. The governance layer 124 comprises a governing contract module 162 operatively coupled to a time locking contract module 164, enabling proposal submission, community voting, and delayed execution of approved actions. Token holders possessing at least a proposal-threshold voting power may submit governance proposals specifying target contracts, function calls, and parameter changes. Voting power is determined based on token balances at a snapshot block, with optional quadratic-bounded voting to mitigate dominance by large holders. Proposals that achieve quorum and receive a majority of votes are queued in the time locking contract module 164, which enforces a governance-defined execution delay to allow for community review or intervention.

The time locking contract module 164 executes proposals only if they comply with immutable safety bounds stored in hardware-protected NVM 110 or encoded in the contract logic, preventing unsafe parameter changes even if approved by governance. In one embodiment herein, the system may include module-scoped emergency pause switches that allow the DAO or authorized governance agents to halt specific contract functions (e.g., buybacks, new allocations, claims) without pausing the entire protocol. This containment strategy minimizes operational disruption while mitigating active threats.

In one embodiment herein, the system 100 implements a series of end-to-end interaction flows that enable a tamper-resistant, compliance-driven investment ecosystem spanning deal creation, funding verification, hedge allocation, token lifecycle management, and governance-driven protocol evolution. The process begins when a startup, operating through the startup console 130 in the client layer 116, agrees to a predefined success-fee arrangement, for example, a five percent (5%) fee. Upon confirmation, the administrative console 132 records the agreed deal terms on-chain via the deal registration contract module 146, triggering a “DealCreated” event comprising a unique DealID and associated success fee percentage. Thereafter, the startup, or an authorized administrator, submits the investor roster along with the corresponding investment amounts through the startup console 130, thereby generating an “InvestmentReported” event within the blockchain layer 120.

Following the successful raising of funds, the agreed success fee is paid in either fiat currency or cryptocurrency. This payment is processed through the invoicing and payment bridge 138 in the off-chain services layer 118, which verifies the receipt and generates a call to the treasury routing contract module 148 via the “RevenueReceipt” function, passing parameters such as the DealID, payment amount, currency hash, and proof hash referencing documentary evidence stored in the audit store 144. The treasury routing contract module 148 then normalizes the revenue using the price oracle adapter 140 exchange rate data and allocates the budget in accordance with DAO-defined proportions, thereby resulting in the emission of an “AllocationBudgeted” event.

Once the allocation budget is established, the allocation management contract module 150 retrieves the latest token price from the price validation contract module 158, calculates the per-investor hedge allocation, and determines the optimal supply path. If the required token quantity remains within the hard-cap limit of one hundred million (100M) tokens, the system 100 mints the necessary amount directly to the vesting management contract module 154. If the requirement exceeds the remaining mintable supply, the system 100 mints only the allowable maximum and invokes the buyback execution contract module 156 to acquire the remaining tokens from approved decentralized exchange liquidity pools. All investor allocations are recorded in immutable vesting schedules with a fixed cliff period of thirty-six (36) months followed by linear release over at least fifty (50) months.

The investors can monitor their allocation and vesting schedules through the investor portal 128 in the client layer 116, with real-time data mirrored by the indexer service 142. Upon completion of the cliff period, the investors may claim the vested tokens, at which point the compliance enforcement contract module 160 revalidates the investor's eligibility, performing Know Your Customer (KYC) and jurisdiction checks based on current regulatory requirements. If eligibility criteria are satisfied, the tokens are released; otherwise, they remain locked until compliance is restored. All token transfers are processed by the token management contract module 152, which enforces a burn of one percent (1%) and a treasury fee of one percent (1%) on each non-exempt transfer, with fee exemption lists managed on-chain by DAO governance.

Changes to privileged protocol parameters, such as fee distribution ratios, buyback execution aggressiveness, or oracle signer configurations, are proposed within the governing contract module 162 of the governance layer 124. The token holders meeting the proposal threshold may submit governance proposals, which, upon achieving quorum and majority approval, are queued within the time locking contract module 164. After the governance-defined execution delay, the time locking contract module 164 executes the approved changes across relevant smart contract modules 122 such as the treasury routing contract module 148, the allocation management contract module 150, the token management contract module 152, and the compliance enforcement contract module 160. This governance-controlled mechanism ensures decentralized, transparent, and secure protocol evolution in compliance with immutable safety bounds stored in the system's hardware-protected NVM 110 or embedded within smart contract logic.

In one embodiment herein, the system 100 incorporates multiple protocol-level safeguards and operational optimizations to ensure secure, compliant, and tamper-resistant investment operations. Token allocations are funded exclusively from attested success-fee revenues processed through the invoicing and payment bridge 138 and verified via on-chain receipts, rather than from investor deposits. The treasury routing contract module 148 records such receipts as multicurrency, oracle-signed proofs, thereby providing immutable on-chain evidence of funding sources. At the time of hedge allocation, the allocation management contract module 150 mints tokens only up to the remaining allowable supply under the hard-cap constraint of one hundred million (100M) tokens. Any shortfall is automatically fulfilled via the buyback execution contract module 156, which acquires the tokens from approved decentralized exchange liquidity pools. This dual-path mechanism ensures that the hard cap is preserved while guaranteeing complete allocation fulfilment to eligible investors.

Compliance checks are applied at two distinct points in the token lifecycle, such as a grant-time permissiveness at the moment of allocation, and a stricter claim-time enforcement executed by the compliance enforcement contract module 160. This structure reduces on-chain friction during allocation while ensuring full regulatory adherence at the moment of asset release to the investor. The deal registration contract module 146 generates immutable, block-height-keyed allocation snapshots at the time of investment reporting. This prevents post-facto modification of investor weights and eliminates potential race conditions between report investment and allocation execution.

The buyback execution contract module 156 incorporates an optional commit-reveal protocol for buyback operations, combined with data freshness guards from the price validation contract module 158, thereby mitigating risks of miner extractable value (MEV) exploitation and on-chain price manipulation. The token management contract module 152 enforces an immutable maximum supply parameter “MAX SUPPLY” that cannot be exceeded under any circumstances, even in the event of allocator misbehavior or faulty execution logic. The governing contract module 162 and the time locking contract module 164 implement immutable safety rails that prohibit governance from setting parameters beyond predefined safe bounds, such as fee rates exceeding acceptable operational thresholds (e.g., 100% fees). These constraints are stored in hardware-protected non-volatile memory 110 or encoded directly in contract logic to prevent catastrophic protocol changes even if approved by token-holder vote.

The term “commit-reveal protocol” refers to a two-phase cryptographic process in which a participant first generates a commitment to a value by submitting a hashed representation of the value together with optional randomness (commit phase), and later discloses the original value and randomness (reveal phase). The validity of the reveal is verified by recomputing the hash and matching it to the commitment. Within the context of the present invention, the commit-reveal protocol is executed inside a Trusted Execution Environment (TEE) and may incorporate a Verifiable Random Function (VRF) to ensure unpredictability and resistance against Miner Extractable Value (MEV) exploitation.

In some embodiments, the system 100 is deployed as part of a startup investment platform, where investors contribute funds to early-stage ventures through a managed deal flow. Startups agree to pay a predefined success fee (e.g., 5-10% of funds raised) to the platform upon successful fundraising or revenue milestones. The success fee is cryptographically attested and submitted on-chain as a revenue receipt. This receipt triggers the token allocation process, where tokens are issued to the original investors as an additional protection layer, funded entirely from the verified success-fee revenue rather than from investor principal. This revenue-funded issuance model ensures that protective token allocations do not dilute the invested capital and directly link token supply growth to real economic activity.

In some embodiments, each non-exempt token transfer within the ecosystem incurs a configurable commission, initially set at 10% of the transferred amount. Of this commission, 5% is distributed proportionally as rewards to existing token holders, 2.5% is allocated to a liquidity pool to support decentralized exchange trading, and 2.5% is permanently burned to reduce circulating supply and support long-term value appreciation. This fee distribution is enforced by the token contract's pre-transfer hook and excludes protocol-controlled addresses such as the vesting contract, treasury, and DAO operations wallet.

Conventional token vesting and compliance systems rely on extensive on-chain storage of allocations, investor attributes, and compliance flags, which significantly increases gas costs and limits scalability. The disclosed system 100 reduces storage consumption by maintaining vesting schedules as immutable contract storage values that do not require repeated updates. Compliance attributes are verified at the claim stage rather than continuously recorded on-chain, thereby avoiding excessive storage writes. This architectural change leads to measurable reductions in blockchain state bloat and execution overhead.

Traditional token life cycle operations, such as buyback or liquidity provisioning, are highly susceptible to Miner Extractable Value (MEV) attacks, where adversarial actors reorder or front-run transactions for profit. The system 100 mitigates MEV risks through a commit-reveal protocol with verifiable random functions (VRFs) executed inside a Trusted Execution Environment (TEE). By separating the commit and reveal phases and adding cryptographically verifiable randomness, transaction ordering becomes unpredictable and resistant to front-running. This provides a significant security enhancement in the blockchain execution layer.

Regulatory compliance in existing blockchain token systems often requires off-chain checks and manual intervention, leading to inefficiencies and inconsistent enforcement. The proposed system 100 provides automated compliance verification by integrating Know Your Customer (KYC) and jurisdictional checks at the claim stage. Because these checks are performed dynamically at the moment of token release rather than at allocation, the system 100 ensures ongoing compliance without necessitating on-chain storage of sensitive attributes. This reduces the risk of stale compliance data and improves the adaptability of the system to evolving regulatory requirements.

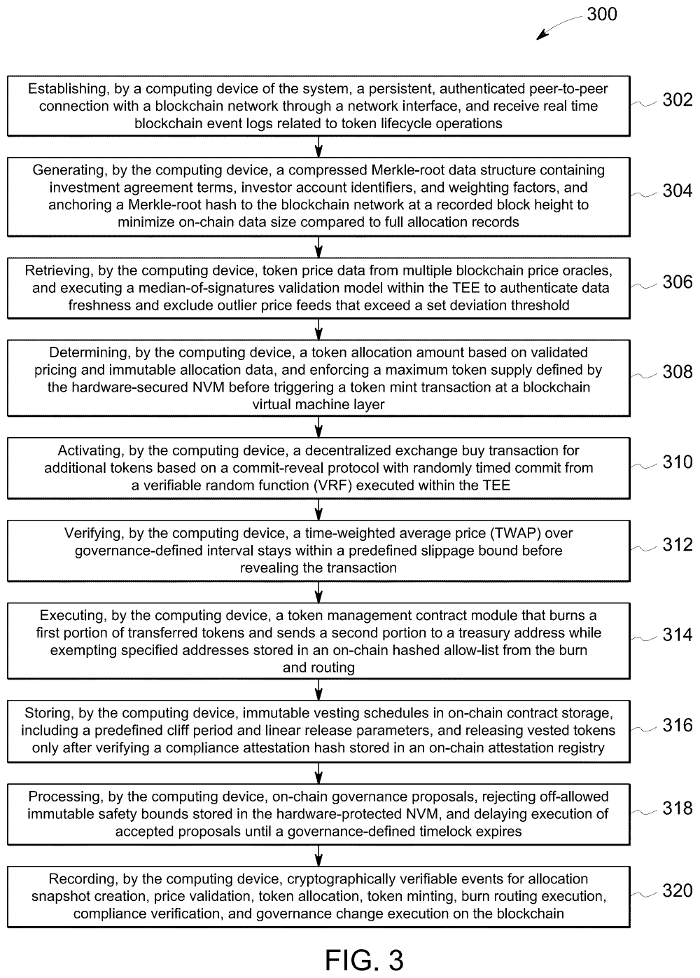

FIG. 3 refers to a flowchart 300 of a method for secure and performance-optimized management of blockchain-based token life cycle operations. First, at step 302, the computing device 102 establishes a persistent, authenticated peer-to-peer connection with the blockchain network 114 through the network interface 112, and receive real time blockchain event logs related to token lifecycle operations. At step 304, the computing device 102 generates the compressed Merkle-root data structure containing investment agreement terms, investor account identifiers, and weighting factors, and anchors a Merkle-root hash to the blockchain network 114 at a recorded block height to minimize on-chain data size compared to full allocation records. At step 306, the computing device 102 retrieves token price data from multiple blockchain price oracles, and executes the median-of-signatures validation model within the TEE to authenticate data freshness and exclude outlier price feeds that exceed a set deviation threshold.

At step 308, the computing device 102 determines a token allocation amount based on validated pricing and immutable allocation data, and enforces a maximum token supply defined by the hardware-secured NVM 110 before triggering a token mint transaction at the blockchain layer 120. At step 310, the computing device 102 activates a decentralized exchange buy transaction for additional tokens based on a commit-reveal protocol with randomly timed commit from the verifiable random function (VRF) executed within the TEE 108. At step 312, the computing device 102 verifies a time-weighted average price (TWAP) over governance-defined interval stays within a predefined slippage bound before revealing the transaction. At step 314, the computing device 102 executes the token management contract module 152 that burns the first portion (1%) of transferred tokens and sends the second portion (1%) to the treasury address while exempting specified addresses stored in an on-chain hashed allow-list from the burn and routing.

At step 316, the computing device 102 stores immutable vesting schedules in on-chain contract storage, including a predefined cliff period and linear release parameters, and releasing vested tokens only after verifying a compliance attestation hash stored in an on-chain attestation registry. At step 318, the computing device 102 processes on-chain governance proposals, rejects off-allowed immutable safety bounds stored in the hardware-protected NVM 110, and delays execution of accepted proposals until a governance-defined timelock expires. Further, at step 320, the computing device 102 records cryptographically verifiable events for allocation snapshot creation, price validation, token allocation, token minting, burn routing execution, compliance verification, and governance change execution on the blockchain.

The system 100 implements a set of interdependent, protocol-level mechanisms that collectively deliver tamper-resistant, compliance-assured, and operationally efficient investor protection. Hedge allocations are funded solely from attested success-fee revenues processed via the invoicing and payment bridge 138, with such receipts recorded as on-chain normalized multicurrency proofs and linked to off-chain evidence anchored in the audit store 144. The allocation management contract module 150 enforces a hybrid model, minting tokens only up to the strict token management contract module 152 hard cap, and routing any remaining requirement to the buyback execution contract module 156 for market acquisition, thereby ensuring allocation fulfilment without breaching the 100M “MAX SUPPLY” constraint. The price validation contract module 158 aggregates multiple independent oracle signatures, applies median filtering, enforces freshness thresholds, and supports pair-chaining to mitigate single-source price anomalies.

The buyback process incorporates commit-reveal sequencing combined with time-weighted average price (TWAP) guards to reduce miner extractable value (MEV) exploitation and slippage risk. Allocation events are keyed to immutable block-height-based snapshots in the deal registration contract module 146, eliminating race conditions and ensuring investor weight immutability after report investment. The allocation process supports batched investor processing within gas limits, applying a documented, deterministic rounding policy to ensure reproducibility and prevent allocation disputes. The compliance enforcement contract module 160 validates investor eligibility at the moment of token claim, accounting for updated jurisdictional restrictions, expired KYC attestations, or regulatory changes.

The governing contract module 162 and the time locking contract module 164 enforce immutable execution guards to prevent governance proposals from introducing unsafe parameters, with all privileged contract upgrades executed through timelocked, DAO-controlled proxies supported by multisignature signer sets. The token management contract module 152 supports both sender- and receiver-side fee exemptions for specific protocol-controlled transfers, with exemption lists hashed and managed on-chain. The vesting management contract module 154 creates immutable vesting schedules comprising a minimum thirty-six (36) month cliff followed by a linear release of at least fifty (50) months, with optional issuance of non-transferable NFTs representing vesting rights. All operational stages, from revenue receipt to claim, are event-emitting, thereby enabling the indexer service 142 to maintain synchronized off-chain dashboards and documentary proofs.

All multicurrency receipts are normalized to protocol base currency at the moment of on-chain recording using oracle-signed exchange rates, ensuring deterministic valuation. Each smart contract module 122, including the treasury routing contract module 148, the allocation management contract module 150, the buyback execution contract module 156, and the compliance enforcement contract module 160, may be paused independently to contain operational risks without halting the entire protocol. An automated chain of protections ties receipt verification to downstream actions, thereby ensuring that only attested, compliant, and fully documented revenue events can trigger allocations. The token transfers enforce protocol-defined burn and treasury accrual percentages, each bounded by immutable safety parameters. All receipts are hashed with unique nonces and expiry timestamps, thereby preventing replay attacks and stale data injection into the allocation process.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the processes described in the foregoing examples without departing from the principles underlying the invention, and all such modifications and alterations are intended to be embraced by this application.

The claimed invention is:

1. A system for secure and performance-optimized management of blockchain-based token life cycle operations, comprising:
a computing device having a processor operatively coupled to a non-transitory memory storing executable instructions, a hardware-based Trusted Execution Environment (TEE), a network interface configured for persistent, authenticated peer-to-peer communication with a blockchain network, and a hardware-protected non-volatile memory storing immutable operational parameters including a maximum allowable token supply and governance safety bounds,
wherein the processor is configured to:
establish a persistent, authenticated peer-to-peer connection with the blockchain network through the network interface, and receive real time blockchain event logs related to token lifecycle operations;
generate a compressed Merkle-root data structure containing investment agreement terms, investor account identifiers, and weighting factors;
anchor a Merkle-root hash of the data structure to the blockchain network at a recorded block height to minimize on-chain storage size compared to full allocation records;
retrieve token price data from multiple blockchain price oracles, and execute a median-of-signatures validation model within the TEE to authenticate data freshness and exclude outlier price feeds that exceed a set deviation threshold;
determine a token allocation amount based on validated pricing and immutable allocation data, and enforce a maximum token supply defined by the hardware-secured NVM before triggering a token mint transaction at a blockchain layer;
activate, through the network interface, a decentralized exchange buy transaction for additional tokens based on a commit-reveal protocol with randomly timed commit from a verifiable random function (VRF) executed within the TEE;
verify that a time-weighted average price (TWAP) over governance-defined interval stays within a predefined slippage bound before revealing the transaction;
execute a token management contract module that burns a first portion of transferred tokens and sends a second portion to a treasury address while exempting specified addresses stored in an on-chain hashed allow-list from the burn and routing;
store immutable vesting schedules in blockchain contract storage, including a predetermined cliff period and linear release parameters, and release vested tokens only after verifying a compliance attestation hash stored in an on-chain attestation registry, where the verification is done within the TEE;
process on-chain governance proposals, reject off-allowed immutable safety bounds stored in the hardware-protected NVM, and delays execution of accepted proposals until a governance-defined timelock expires; and
record cryptographically verifiable events for allocation snapshot creation, price validation, token allocation, token minting, burn routing execution, compliance verification, and governance change execution on the blockchain.

2. The system of claim 1, wherein the processor generates the Merkle-root data structure by hashing concatenated deal data, investor account identifiers, and the blockchain block height and compresses data into a minimum-depth Merkle tree to minimize computational verification overhead.

3. The system of claim 1, wherein the trusted execution environment (TEE) stores private keys used for price verification, prevents unauthorized reads of memory, and provides a signed attestation of validated price data to the blockchain network.

4. The system of claim 1, wherein the commit-reveal protocol employs the VRF seed to create unpredictable commit timestamps, thereby preventing transaction ordering manipulation by blockchain miners and validators.

5. The system of claim 1, wherein the token management contract module is deployed as an ERC-20-compatible contract with an embedded burn-and-route mechanism executed at a pre-transfer hook phase before balance updates in the blockchain virtual machine layer.

6. The system of claim 1, wherein the cryptographically verifiable events are recorded with an event-topic indexing scheme to allow off-chain auditors to extract targeted event categories without searching unrelated blockchain data.

7. The system of claim 1, wherein the blockchain network combines off-chain Know Your Customer (KYC), Anti-Money Laundering (AML), invoicing, and price feed services into the blockchain network, with each periodically sealing a Merkle-root commitment of service data on-chain for independent auditing.

8. The system of claim 1, wherein the immutable vesting schedules impose a cliff period of 36 months followed by a linear release schedule of 50 months, and prevent any release transaction for which compliance attestation verification is not completed.

9. A computer-implemented method for secure and performance-optimized management of blockchain-based token life cycle operations, comprising:
establishing, by a computing device of the system, a persistent, authenticated peer-to-peer connection with a blockchain network through a network interface, and receive real time blockchain event logs related to token lifecycle operations;
generating, by the computing device, a compressed Merkle-root data structure containing investment agreement terms, investor account identifiers, and weighting factors, and anchoring a Merkle-root hash to the blockchain network at a recorded block height to minimize on-chain data size compared to full allocation records;
retrieving, by the computing device, token price data from multiple blockchain price oracles, and executing a median-of-signatures validation model within the TEE to authenticate data freshness and exclude outlier price feeds that exceed a set deviation threshold;
determining, by the computing device, a token allocation amount based on validated pricing and immutable allocation data, and enforcing a maximum token supply defined by the hardware-secured NVM before triggering a token mint transaction at a blockchain virtual machine layer;
activating, by the computing device, a decentralized exchange buy transaction for additional tokens based on a commit-reveal protocol with randomly timed commit from a verifiable random function (VRF) executed within the TEE;
verifying, by the computing device, a time-weighted average price (TWAP) over governance-defined interval stays within a predefined slippage bound before revealing the transaction;
executing, by the computing device, a token management contract module that burns a first portion of transferred tokens and sends a second portion to a treasury address while exempting specified addresses stored in an on-chain hashed allow-list from the burn and routing;
storing, by the computing device, immutable vesting schedules in on-chain contract storage, including a predefined cliff period and linear release parameters, and releasing vested tokens only after verifying a compliance attestation hash stored in an on-chain attestation registry;
processing, by the computing device, on-chain governance proposals, rejecting off-allowed immutable safety bounds stored in the hardware-protected NVM, and delaying execution of accepted proposals until a governance-defined timelock expires; and
recording, by the computing device, cryptographically verifiable events for allocation snapshot creation, price validation, token allocation, token minting, burn routing execution, compliance verification, and governance change execution on the blockchain.

10. The method of claim 9, wherein the processor generates the Merkle-root data structure by hashing concatenated deal data, investor account identifiers, and the blockchain block height and compresses data into a minimum-depth Merkle tree to minimize computational verification overhead.

11. The method of claim 9, wherein the trusted execution environment (TEE) stores private keys used for price verification, prevents unauthorized reads of memory, and provides a signed attestation of validated price data to the blockchain network.

12. The method of claim 9, wherein the commit-reveal protocol employs the VRF seed to create unpredictable commit timestamps, thereby preventing transaction ordering manipulation by blockchain miners and validators.

13. The method of claim 9, wherein the token management contract module is deployed as an ERC-20-compatible contract with an embedded burn-and-route mechanism executed at a pre-transfer hook phase before balance updates in the blockchain virtual machine layer.

14. The method of claim 9, wherein the cryptographically verifiable events are recorded with an event-topic indexing scheme to allow off-chain auditors to extract targeted event categories without searching unrelated blockchain data.

15. The method of claim 9, wherein the blockchain network combines off-chain Know Your Customer (KYC), Anti-Money Laundering (AML), invoicing, and price feed services into the blockchain network, with each periodically sealing a Merkle-root commitment of service data on-chain for independent auditing.

16. The method of claim 9, wherein the immutable vesting schedules impose a cliff period of 36 months followed by a linear release schedule of 50 months, and prevent any release transaction for which compliance attestation verification is not completed.
